(19) United States
(12) Patent Application Publication
(10) Pub. No.: US 2021/0247809 A1
(43) Pub. Date: Aug. 12, 2021

(54) MOUNTABLE LAPTOP PORTABLE CHARGER

(71) Applicant: Irtaza Abbas Razvi, Jericho, NY (US)

(72) Inventor: Irtaza Abbas Razvi, Jericho, NY (US)

(21) Appl. No.: 16/789,403

(22) Filed: Feb. 12, 2020

(51) Int. Cl. G06F 1/16

(52) U.S. Cl. CPC G06F 1/1635; G06F 2200/1634; G06F 1/1607

(57) ABSTRACT

The mountable laptop portable charger provides a power source to a computing system. The device has a central case and a plurality of attachment arms having a first end coupled to the central case and a second end coupled to an attachment clip. The central case having a cavity to hold a power source to be connected to the computing system. The attachment arms may be rigid folding arms, stretchable attachment cables, or retractable attachment cables.

### TECHNICAL FIELD

This application relates in general to an article of manufacture for providing a mountable laptop portable charger.

### BACKGROUND

Users of laptops and mobile devices such as tablet computers depend upon an ability to provide and maintain power to run the devices. Laptops have internal batteries which are rechargeable and are able to run the devices without being plugged into an AC outlet. The internal batteries are recharged when the laptops are connected to a power source, which typically an AC-to-DC power converter that is plugged into a wall outlet. The external batteries may also be recharged when the laptops are plugged into an external battery that provides the same DC voltage as the power converter.

Use of either of these types of power sources provide a device that needs to be close enough to the laptop to permit the DC power cable to be plugged into the power input connector. These cables and power converters or batteries may present limitations to the location where the user may use the laptop. Providing a mechanism to easily restrain these power sources to the laptop would make use of the laptop more convenient. However, attaching or restraining the power sources should be in a location that keeps the power source out of the way while remaining easy to attach and remove from the laptop when the external power source is not needed.

The present invention attempts to address the existing limitations in retain a power source for a laptop computer according to the principles and example embodiments disclosed herein.

### SUMMARY

In accordance with the present invention, the above and other problems are solved by providing an article of manufacture for providing a mountable laptop portable charger.

In one embodiment, the present invention is mountable laptop portable charger device for providing a power source to a computing system. The device has a central case and a plurality of attachment arms having a first end coupled to the central case and a second end coupled to an attachment clip. The central case having a cavity to hold a power source to be connected to the computing system.

Another embodiment of the present invention is a mountable laptop portable charger device for providing a power source to a computing system. The device includes a battery, a central case for a battery housing, a plurality of attachment arms having an inner end coupled to central case and an outer end, and an attachment mechanism coupled to outer end of the attachment arms.

The great utility of the invention is that an article of manufacture may provide a mechanism to easily restrain these power sources to the laptop would make use of the laptop more convenient while attaching or restraining the power sources in a location that keeps the power source out of the way while remaining easy to attach and remove from the laptop when the external power source is not needed.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment an article of manufacture for mountable laptop portable charger according to the present invention.

FIG. 2a-b illustrates another view of one possible embodiment mountable laptop portable charger according to the present invention.

FIG. 3a-3b illustrates yet another pair of views of one possible embodiment mountable laptop portable charger according to the present invention.

FIG. 4a-4d illustrates an additional pair of views of one possible embodiment mountable laptop portable charger according to the present invention.

FIG. 5 illustrates a view of one possible embodiment mountable laptop portable charger attached to an example laptop according to the present invention.

FIGS. 6a-d illustrates a second possible embodiment mountable laptop portable charger according to the present invention.

FIG. 7a-h illustrate a third possible embodiment mountable laptop portable charger and its attachment to an example laptop according to the present invention.

FIG. 8a-g illustrate additional embodiments of the third possible embodiment mountable laptop portable charger and its attachment to an example laptop according to the present invention.

FIGS. 8e-f illustrate example embodiments of pulley arrangements usable in providing the cable extension and retraction of various embodiments of the present invention.

FIG. 9a-b illustrate additional embodiments of the fourth possible embodiment mountable laptop portable charger and its attachment to an example laptop according to the present invention.

FIG. 10a-b illustrate a fifth possible embodiment mountable laptop portable charger and its attachment to an example laptop according to the present invention.

### DETAILED DESCRIPTION

This application relates in general an article of manufacture for providing a mountable laptop portable charger.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

The term “laptop” refers to a mobile computing device having a screen for presenting images to users while operating the device. “Tablets,” “iPads™,” and “Surface™”, “Nook™”, “Kindle™” and similar devices in which a user utilizes a touch screen to provide input signals to the device may also be some of the many possible embodiments for the claimed invention. All of the above terms may be used interchangeably without deviating from the scope of the invention as defined in the attached claims.

The term “user” and “individual” refers to an entity, e.g. a human, that operates a device according to the present invention in order to bring about a desired effect or outcome, particularly provide the user an ability to support an instrument. In a particular case, the user is one that is playing a viola or violin. For such a user, the terms “user” and “individual” may be used herein interchangeably.

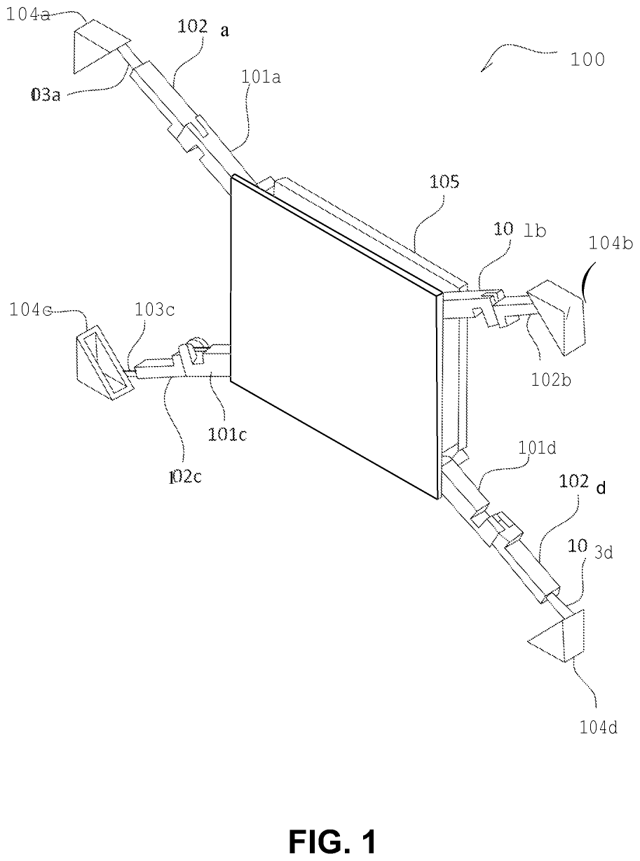

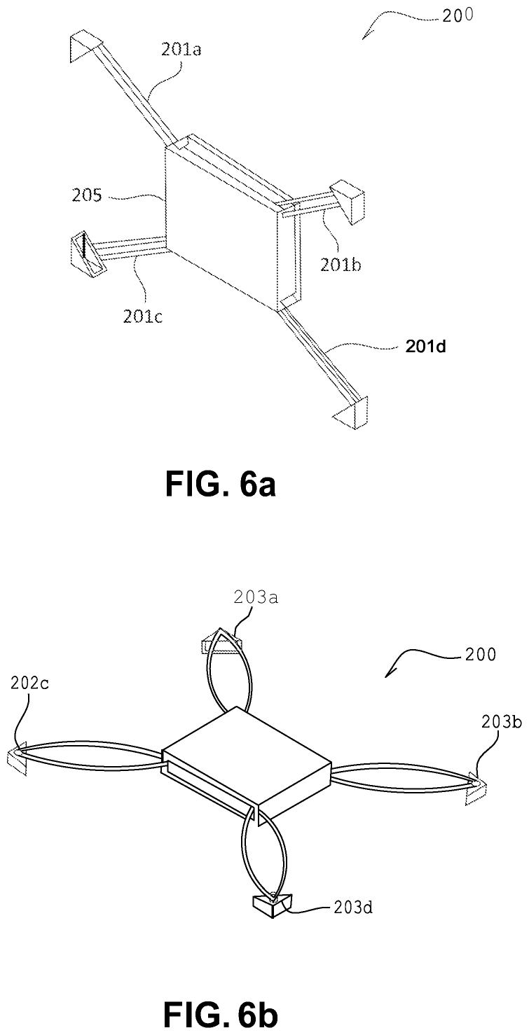

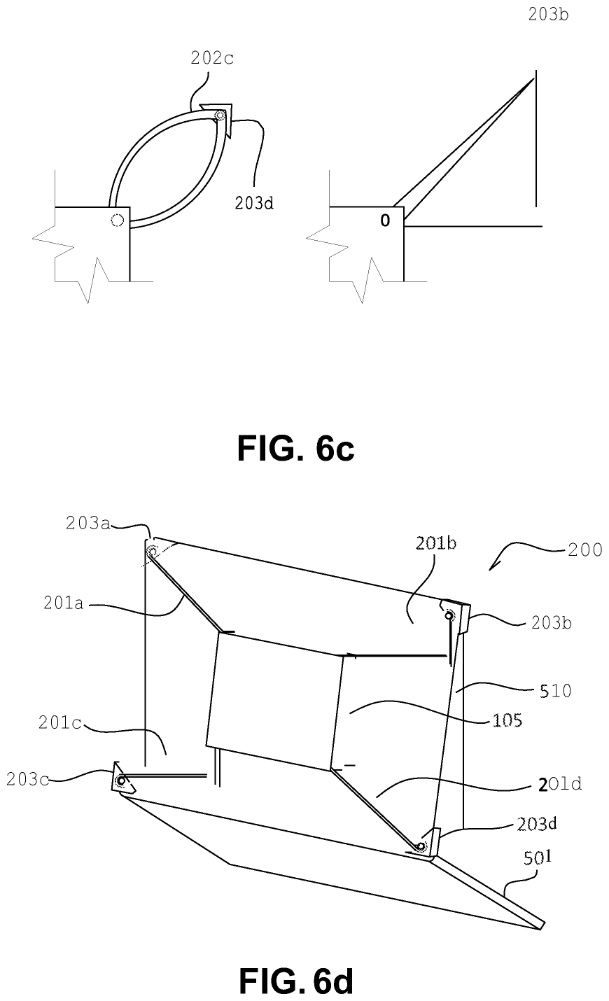

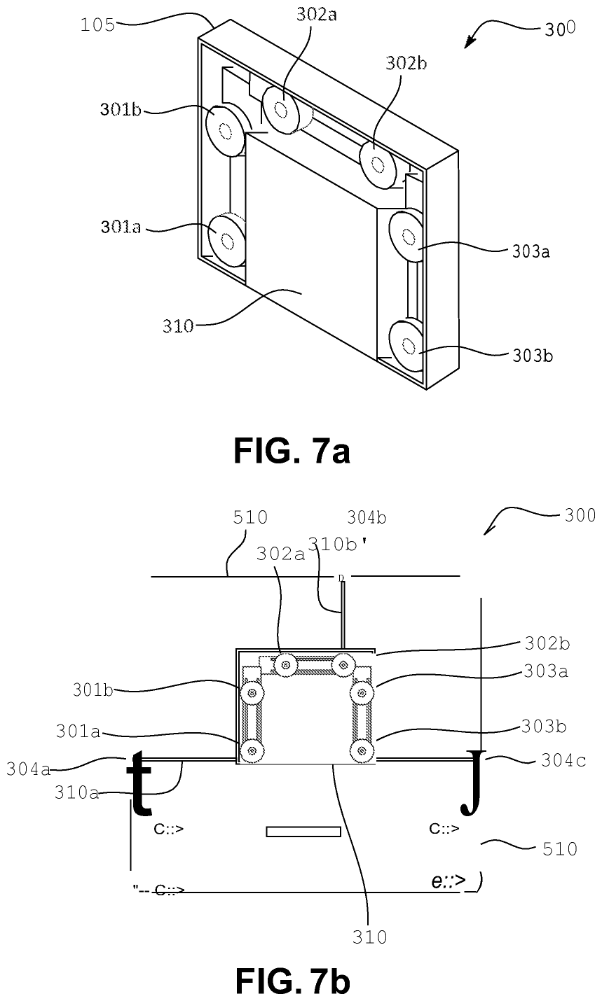

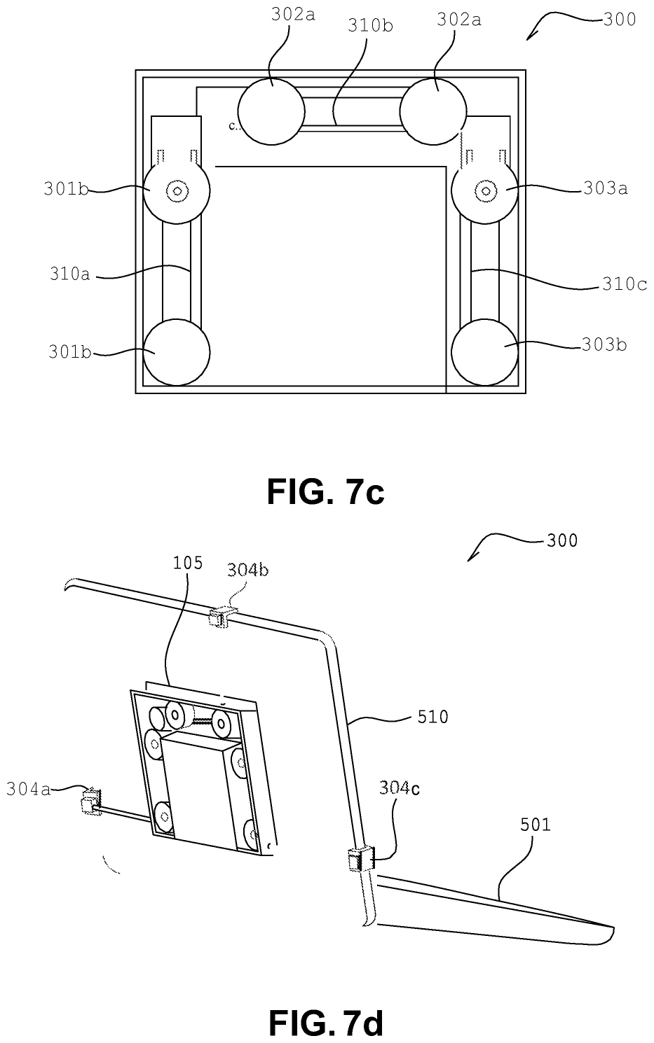

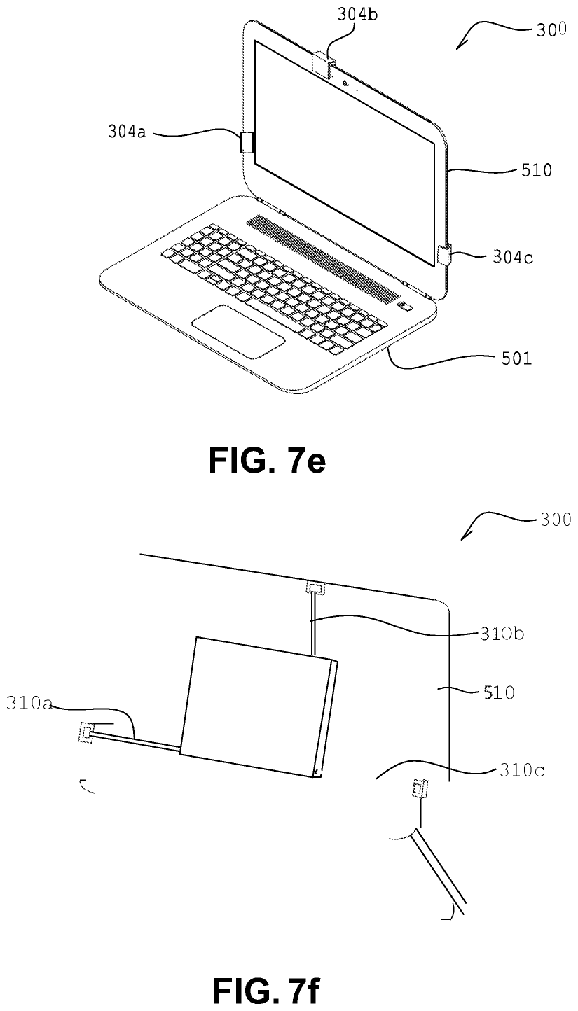

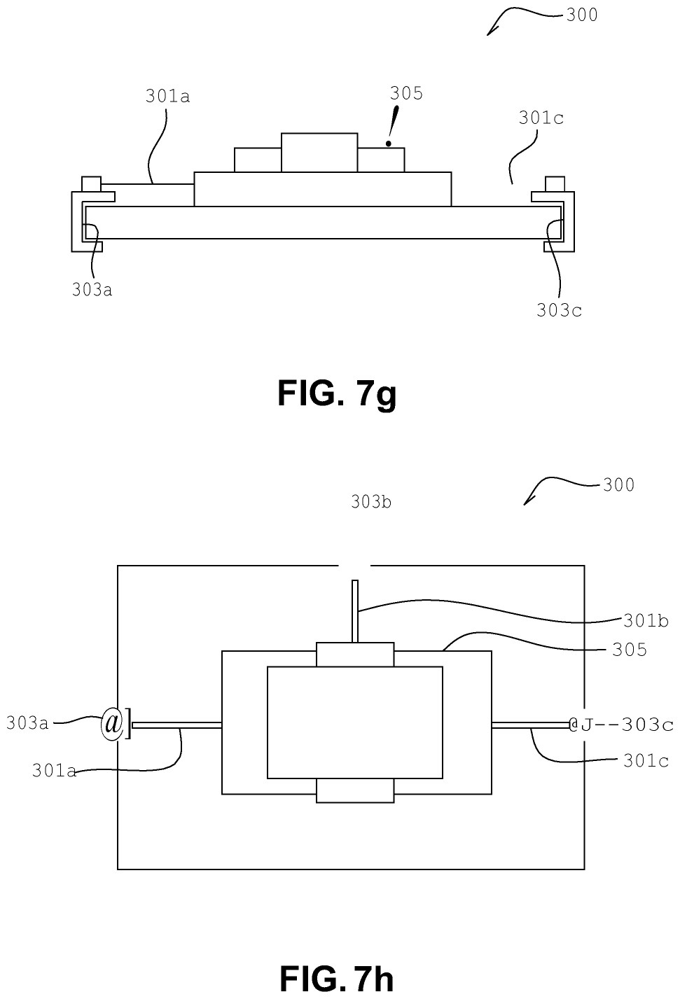

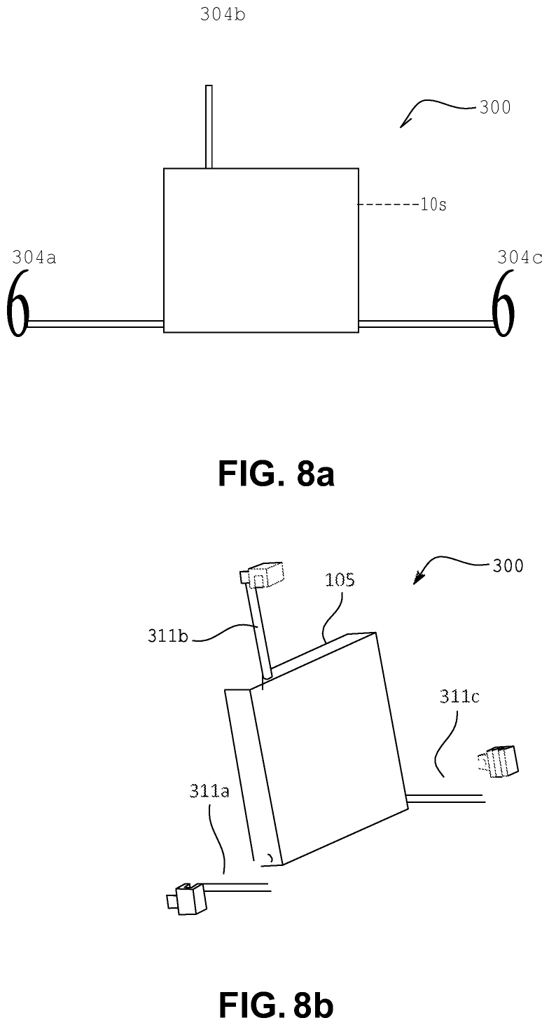

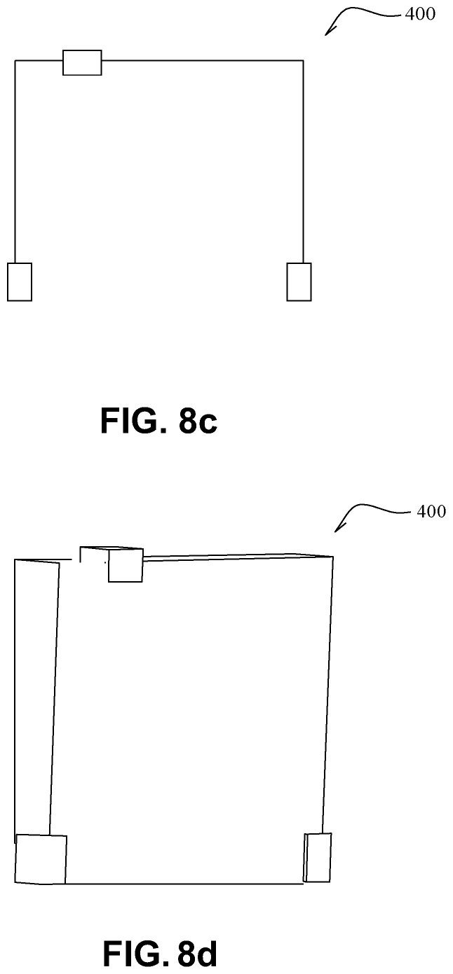

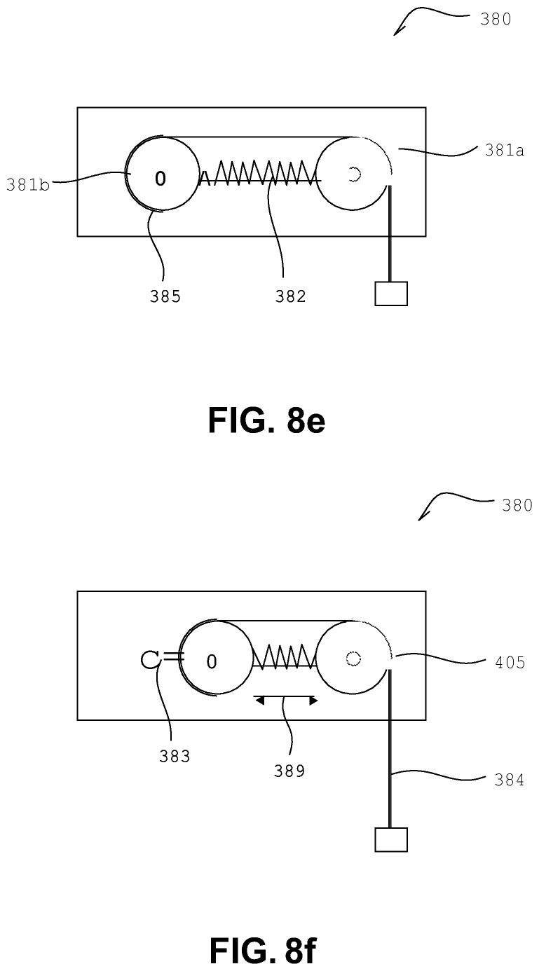

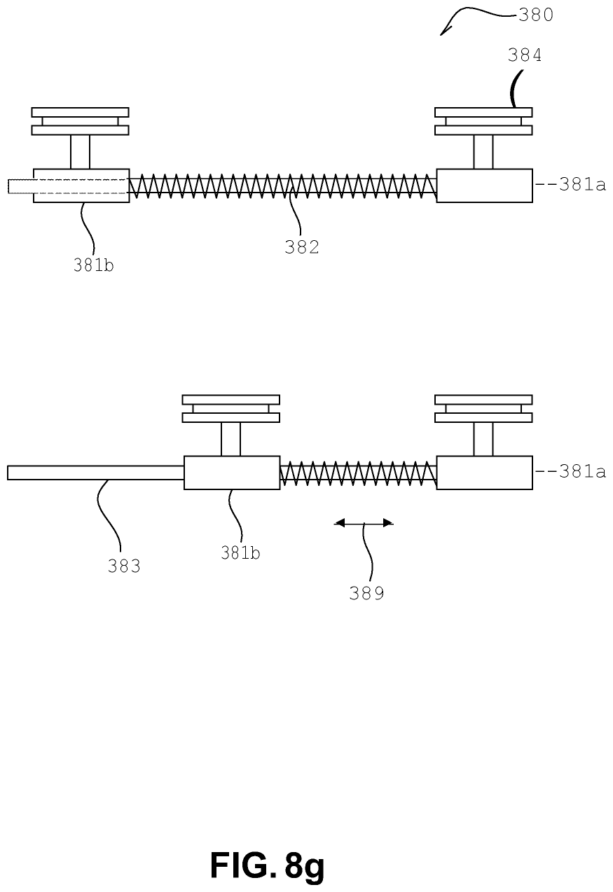

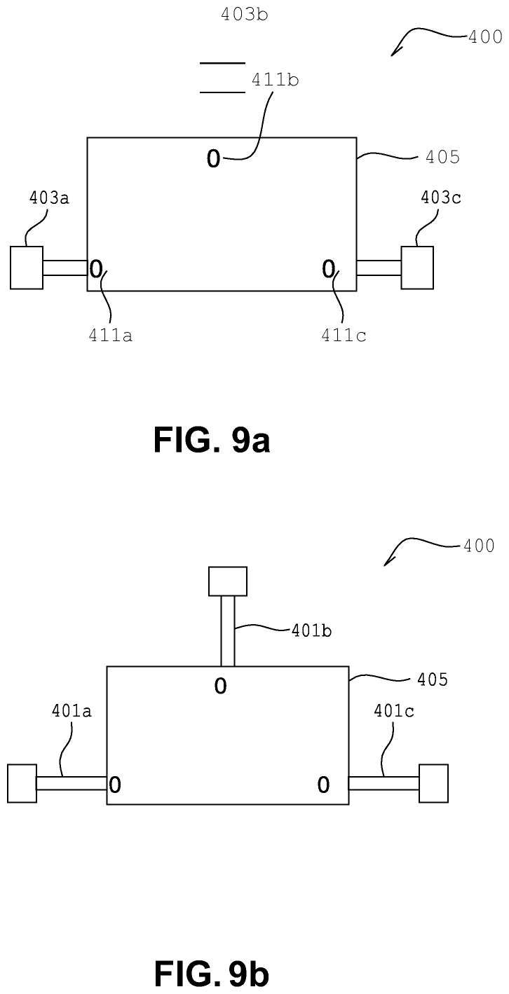

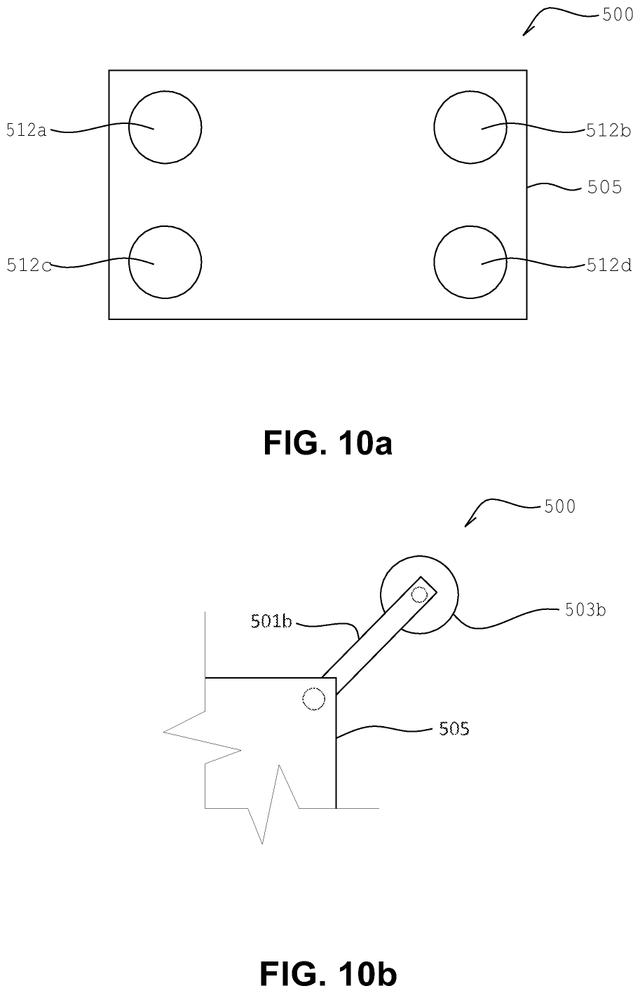

In general, the present disclosure relates general an article of manufacture for providing mountable laptop portable charger for restraining a power source to a computing device such as a laptop and tablet. To better understand the present invention, FIGS. 1-5 represent one potential embodiment of general an article of manufacture mountable laptop portable charger according to the present invention. FIGS. 6a-d represent a second potential embodiment of general an article of manufacture mountable laptop portable charger according to the present invention. FIGS. 7a-h represent a third potential embodiment of general an article of manufacture mountable laptop portable charger according to the present invention. FIGS. 8a-b represent a fourth potential embodiment of general an article of manufacture mountable laptop portable charger according to the present invention. FIGS. 9a-d represent a fifth potential embodiment of general an article of manufacture mountable laptop portable charger according to the present invention. FIGS. 10a-b represent a sixth potential embodiment of general an article of manufacture mountable laptop portable charger according to the present invention. These for example embodiments are not to be interpreted as being all of the possible embodiments of the present invention. The attached claims provide a definition of the present invention and provide the limits of the scope covered by the present invention.

With regard to all of the embodiments disclosed herein, a mountable laptop portable charger 100 is a device that can easily attach itself to a back side of a screen that is part of a typical laptop 501. The device contains a mechanism to attach the device 100 onto the laptop screen 510 that both remains in place until during normal use of the laptop 501 and disengages the screen 510 with a minimal amount of effort when desired. The device 100 also contains a cavity 201 into which a power source for supplying the laptop 501 with electrical energy to operate and/or recharge an internal battery.

The power source, not shown, typically consists of an AC-to-DC power converter that receives AC voltage from an ordinary two or three-pronged plug and provides a single DC voltage used by the laptops. In all embodiments, the device 100 possesses one or more openings into and out of the device cavity 201 thru which power cables may pass. These cables may be routed to an ordinary wall outlet and to the power input connectors. Depending upon the size of the cavity 201 within the device 100, any unneeded cable may be coiled into a minimal size within the cavity 201 along with the power converter.

Because laptop manufacturers have used a variety of connector types to provide power to the laptop 501 and to recharge an internal battery, various cable types may be used with the device 100. Additionally, because these laptops 501 possess a variety of screen sizes, the device 100 may be made with a variety of sizes with cavities differing in size to hold the power converter and associated cables. Other power sources such as a battery may also be used within the device 100 that would require only one cable to the laptop 501 where the battery may be removed from the device and recharged in all known means. As noted above, the laptop 501 may also be a tablet computing device having a touch sensitive screen and no external keyboard in which device 100 may be attached to provide power to the tablet.

FIGS. 1-5 illustrates various views for one potential embodiment an article of manufacture for mountable laptop portable charger according to the present invention. Device 100 is constructed having a central case 105 and a plurality of lower attachment arms 101a-d and folding arms 102a-d. The central case 105 is shown in figures to have a rectangular shape. Other shapes may be used.

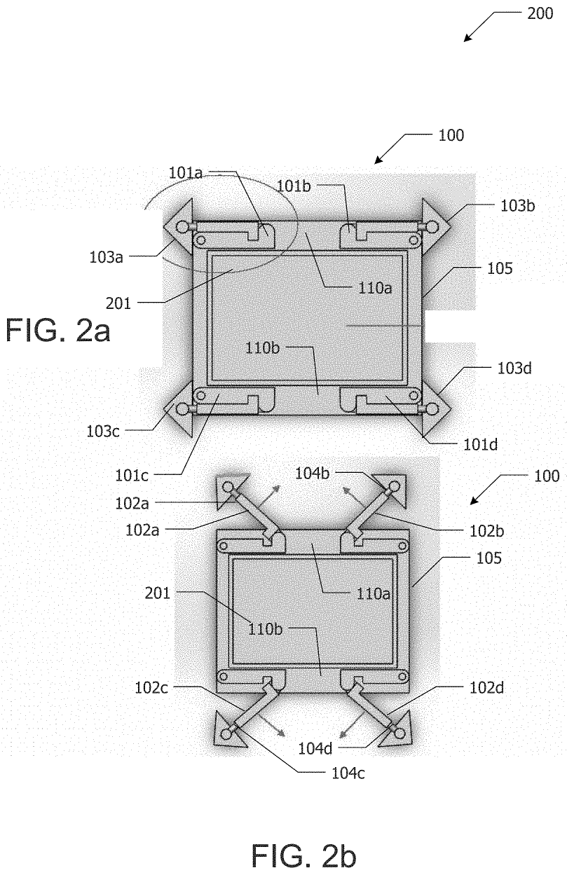

The central case 105 is shown in this particular embodiment with a cable channel 110a-b on opposing sides of the central case 105 as shown in FIG. 2a. Various embodiments may possess more or less than 2 cable channels 110a-b in a plurality of locations around the central case 105 if appropriate. The central case 105 is shown in FIG. 1 as having a removable cover 108 to keep the power source and cables organized and within the cavity 201.

This first embodiment possesses 4 lower attachment arms 101a-101d that are attached to the central case 105 at the corners. Each attachment arm 101a also has corresponding folding arm 102a to match the distant between the central case 105 and a corner 502a-d of the laptop screen 501. One end of the attachment arm, which is a straight arm member, that is coupled to the corner of the central case 105 at one end and coupled to an inner end of the folding arm 102a at its opposite end. The folding arms 112a-d are also a straight member that in addition to being coupled to their respective lower attachment arms 101a-d and also are coupled to a corner connector 103a.

Each of the attachment mechanisms, in this embodiment corner connectors 103a-d, as shown in FIG. 1, have a triangular shape with a screen slot, see slot 114c for example, that is sized to permit the each of four corners of the laptop screen 510 to be placed within these slots 110a-d within their respective corner connectors 103a-d. With all four corners of laptop 501 being within the four slots 107a-d, the central device 105 is held is place by opposing forces from each of the lower attachment arm 101a-d/folding arm 102a-d combination.

Each of the folding arms 102a-d contain an extension arm 104a-d that permits the corresponding corner connectors 103a-d to move away from the central case. If the extension arms 104a-d include a tension mechanism (not shown) between the extension arms and the corresponding folding arms 102a-d, the corner connectors will be pulled back against the central case 105 when the arms are folded inward and will be pulled back to create the opposing forces that hold the device 100 in place when the corners of the laptop screen 510 are within the slots 110a-d. The tension mechanism may include a spring, a short length of bungy cord, or a similar stretchable material that holds the extension arms 104a-d within the corresponding folding arm 102a-d.

The embodiment of FIGS. 1-5, is shown as permitting each folding arm 102a-d capable of pivoting about their respective connection points to align itself along the corresponding lower attachment arms 101a-d. The folded combination of folding arms 102a-d and lower attachment arms 101a-d themselves pivots about a connection point between the attachment arms and the corresponding corner of the central case 105. The central case 105 also possesses slots 107 about its external edges that are sized to permit the two-arm combination to fold into a position flush within the slots against the central case 105. If the lower attachment arms 101a-d are sized to match the length of the folding arms 102a-d, and if the lower attachment arms 101a-d and folding arms 102a-d pivot inward in an opposite direction that the lower attachment arms 101a-d pivot towards the central case 105, the respective corner connectors 103a-d may lie flush against the outer edge of the central case 105 as shown in FIG. 2A.

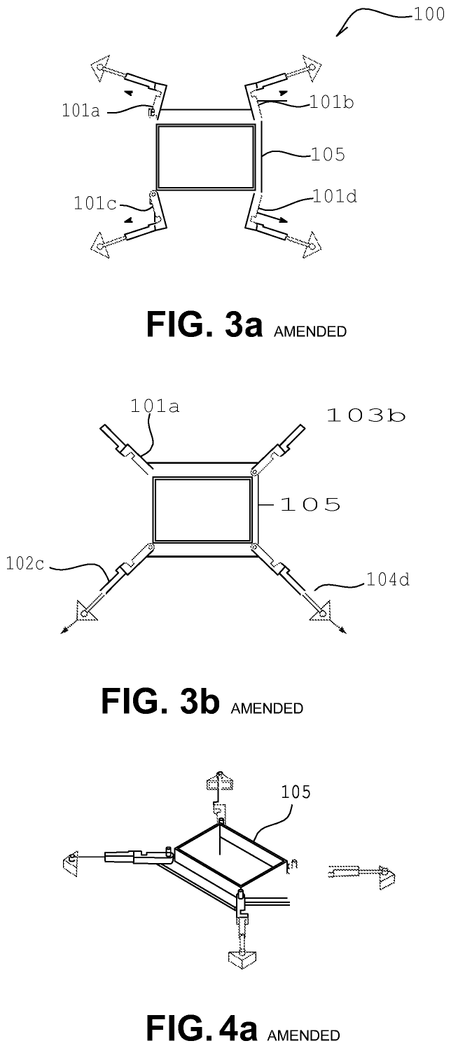

FIGS. 3a-3b illustrate the unfolding of the combination of arms to a fully open state. FIG. 3c show another view of device 100 having the combination of arms in a fully open state. FIG. 3c also shows an inner cavity 201 within central case 105 used to restrain the power source and cables therein.

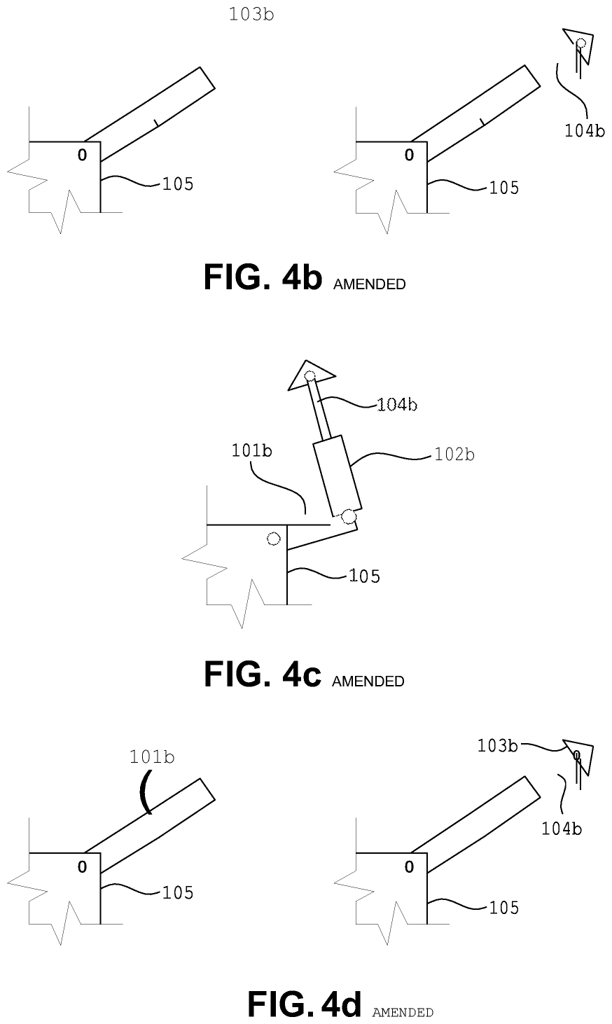

FIGS. 4a-c illustrate additional embodiments of folding and extending arms usable with the first embodiment of the present invention. FIG. 4a show an unfolded arm 101b, 102b. in which extension arm 104b is shown at different position of extension. FIG. 4b shows a partially folded arm 101b, 102b with the extension arm 104b extended. In all examples, the corner connector 103b is shown on one end of the extension arm 104b. FIG. 4c shows a similar extending arm 141a that is a single, rather than a two-piece folding arm, that includes an extension arm 104b and corner connector 103b as above.

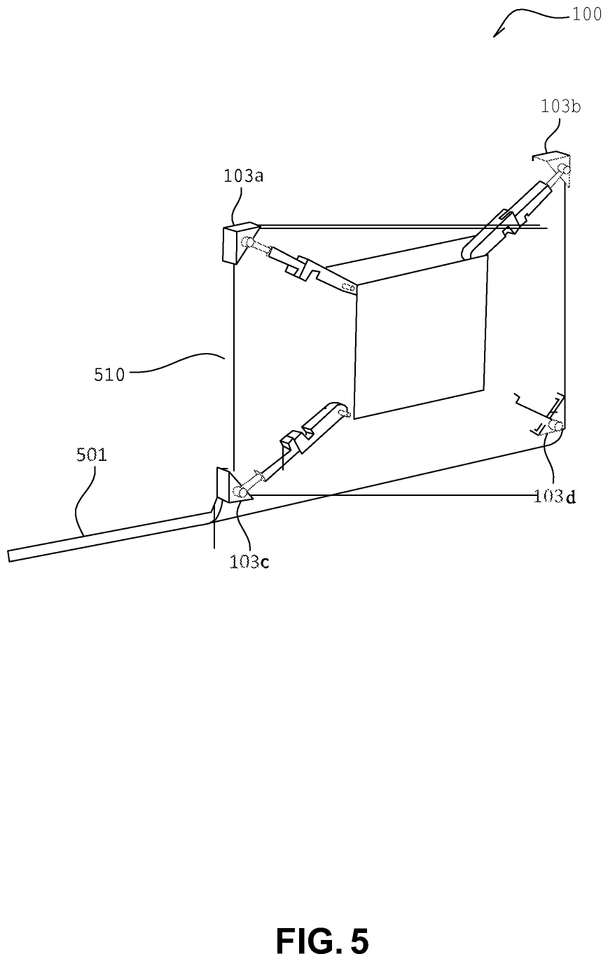

FIG. 5 illustrates a view of one possible embodiment mountable laptop portable charger attached to an example laptop according to the present invention. The four corner connectors 103a-d are placed over the corners of the laptop screen 510 to hold the central body 105 in place on the back of the screen.

FIGS. 6a-d illustrates multiple views of a second possible embodiment mountable laptop portable charger according to the present invention. In this embodiment, the device 200 includes a central case 205 and a plurality of attachment cables 201a-d coupled to the central case 205 at its corners. Each attachment cables 201a-d possess corresponding corner connectors 203a-d for their attachment mechanism. These corner connectors 203a-d function, similarly to the corner connectors 103a-d described above, to attach the central case 205 to the laptop 501.

The attachment cables 201a-d are made from elastic material such as bungie cord, rubber bands, or similar material in which an opposition force is created when the corner connectors 203a-d and pulled away from the central case 205. When each of the corner connectors are pulled away from the central case 205 and are placed over a corner of a laptop screen 510, the central case 205 are suspended against the laptop screen as shown in FIG. 6d.

The central case 205 may be similar to the central case 105 described above. As such, the central case 205 may include cable channels, and power source-cable cavity. Power sources such as power converters and batteries may be stored within the cavity (not shown) in a manner similar to the cavity 201 as discussed above with respect to FIG. 2a.

Device 200 is shown with the attachment cables 203a-d stretched to a point at which the opposition forces are generated by each cable In FIG. 6. Device 200 is shown with the attachment cables 203a-d in a relaxed condition. In a relaxed condition, each of the attachment cables 203a-d appear as a loop of material attached to a corresponding corner of the central case 205 by having the loop material passing around an attachment post. Other attachment mechanisms such as glue, epoxy, screws, and similar mechanisms for coupling the cables 203a-d to the case 205. The shape of attachment cable 203b is shown in a relaxed and extended shape in FIG. 6c.

FIG. 6d illustrates a view of one possible embodiment mountable laptop portable charger attached to an example laptop according to the present invention. The four corner connectors 203a-d are placed over the corners of the laptop screen 510 to hold the central body 105 in place on the back of the screen.

FIGS. 7a-h a third possible embodiment mountable laptop portable charger and its attachment to an example laptop according to the present invention. The third possible embodiment ids device 300 having a central case 305 and three attachment cables 310a-c. The central case 305 provides all of the features describe above with reference to having a cavity 311 to hold various types of power sources and their respective cables. The central case 305 attaches to the laptop 501 using three attachment mechanisms, which in this case are attachment clips 304a-c that couple to the outside edge of the laptop screen 510.

One attachment clip 304b is coupled to the laptop screen 510 on its top edge. The remaining clips 304a,c couple to the opposing sides of the laptop screen 510. Attachment cable 310b generally supports the weight of the central case 305 as it hangs down from the top of the laptop screen 510. The remaining clips 304a,c restrain the central case 305 to prevent it from swaying from side to side. The attachment clips 304a-c are a U-shaped clip device one end of the attachment cables 310a-c on its outside surface at the bottom of the U-shaped piece. The two opposing arms that form the U-shaped clip are angled slightly towards each other such that when the laptop screen 510 is inserted between them and within the clips 304a-c that a restraining force is created to keep the clips in a fixed location. FIGS. 7b-c and 7e-h show various views of the device 300 being attached to the laptop 501 on the rear of the laptop screen 510.

The opposite ends of the attachment cables 310a-c are arranged to pass inside of the central case 305 and are wrapped around pulley wheels to keep the cables coupled to the central case 305. Each of the attachment cables 310a-c are wrapped around its own pair of pulley wheels. Attachment cable 304a is wrapped around pulley wheels 301a-b. Attachment cable 304b is wrapped around pulley wheels 302a-b. Attachment cable 304c is wrapped around pulley wheels 303a-b.

Each pair of pulley wheels create a spring-loaded attachment for the corresponding attachment cable such that the cable will automatically retract around the pulley pair when not in use. The spring-loaded attachment of the attachment cables 310a-c also generates an opposing force against the attachment clips 304a-c to hold the central case 305 in place. FIGS. 8a-d show various views of the device 300 with the attachment cables 310a-c both retracted and extended.

FIGS. 8e-g illustrate example embodiments of pulley arrangements usable in providing the cable extension and retraction of various embodiments of the present invention. The pulley system 380 includes one or more pulleys 381a-b a spring 382 an axial track 383 a pulley cable 384 and a mounting mechanism 385.

The mounting mechanism 385 connected to a pulley cable 384 The pulley cable 384 wraps around a stationary pulley 381a which is allowed to rotate, then around a variable pulley 381b which does not rotate, where it is fixed to the variable pully 381b. The variable pulley 381b moves in a linear fashion 389 as shown in FIG. 8f. The variable pulley 381b is mounted on the axial track 383 On this axial track 383, the spring 382 which forces the variable pully 381b back to its original position when the pulley cable 384 is pulled and extended. In other words, the spring 382 creates an opposing force which in turn creates tension. As the pulley cable 382 is pulled, the distance between the variable pulley 381b and the stationary pulley 381a decreases.

FIG. 9a-b illustrate a fourth possible embodiment mountable laptop portable charger and its attachment to an example laptop according to the present invention. In this embodiment, central case 405 uses three attachment cables 401a-c with corresponding attachment clips 403a-c acting as an attachment mechanism at their respective ends. This embodiment differs from the prior embodiment in that a single spring-loaded pulley 411a-c are used in place of the variable/stationary pulley system 380 described above. In all other actions, this embodiment may function in similar ways as any of the other embodiments. These variations permit batteries and power converters to be stored in the central case 405, permits attachment clips to include corner connectors and u-shaped clips, and similar attachment mechanisms, and permits various materials to be used for the attachment cables 401a-c in the fourth embodiment as defined in the attached claims.

FIG. 10a-b illustrate a fifth possible embodiment mountable laptop portable charger and its attachment to an example laptop according to the present invention. In this embodiment, a central case 405 is attached to a laptop 501 with attachment mechanism coupled at the end of attachment arms 501b. In this embodiment, the attachment mechanism uses a suction cup 503b on each of the attachment arms 501b. Additional suction cups 512a-d may also be coupled to a back side of the central case 505 to hold the central case in place on a laptop screen 510.

As above, this embodiment may function in similar ways as any of the other embodiments. These variations permit batteries and power converters to be stored in the central case 505, permits attachment mechanism to include corner connectors and u-shaped clips in addition to the suction cups, and similar attachment mechanisms, and permits various materials to be used for the attachment arms 503b in the fifth embodiment as defined in the attached claims.

One of ordinary skill will recognize that the attachment mechanism may use any number of means to couple the attachment mechanism to the laptop screens. In the various embodiments, the attachment mechanism includes a corner connector, a u-shaped clip, and a suction cup. Other attachment mechanisms may also include pads attached to attachment arms or attachment cables that couple the pads to the laptop screen using other removable mechanisms such as Velcro™, double-sided tape, rubber cement and similar adhesives, hooks, linear track locks, and related means. Additionally, the attachment arms are shown to be solid and foldable arms, stretchable cables, and retractable cables using a variety of pulley arrangements. These mechanisms and similar means to connect the central case to the outer edge of the laptop screen to support the weight of the central case may also be used. In all of these variations, the present invention is limited to only the limitations recited in the attached claims.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

1. A mountable laptop portable charger device for providing a power source to a computing system, the device comprises:
a central case, the central case having a cavity to hold a power source to be connected to the computing system; and
a plurality of attachment arms having a first end coupled to the central case and a second end coupled to an attachment clip.

2. The mountable laptop portable charger device according to claim 1, wherein the attachment arms are a lower attachment arm/folding arm pairs having a one end of each member of the pair coupled together, a first opposing end of the lower attachment arm is coupled to the central case, and a second opposing end of the folding arm is coupled to the attachment clips.

3. The mountable laptop portable charger device according to claim 3, wherein each attachment clip comprises a corner connector.

4. The mountable laptop portable charger device according to claim 1, wherein the attachment arms being attachment cable made of stretchable material having an extended position in which the attachment arms respective attachment clips couple to the computing system.

5. The mountable laptop portable charger device according to claim 4, wherein the stretchable material of the attachment arms comprises bungie cable, rubber band, and elastic fabric.

6. The mountable laptop portable charger device according to claim 5, wherein a first end of the attachment cables being coupled to the central case and the opposing end of the attachment cables being coupled to the attachment clip.

7. The mountable laptop portable charger device according to claim 6, wherein each attachment clip comprises a corner connector.

8. The mountable laptop portable charger device according to claim 6, wherein each attachment cable is coupled to the central case by having each attachment cables routed around a self-retracting pair of pulleys.

9. The mountable laptop portable charger device according to claim 1, wherein the power source is a battery.

10. The mountable laptop portable charger device according to claim 1, wherein the power source is an AC-to-DC power converter.

11. A mountable laptop portable charger device for providing a power source to a computing system, the device comprises:
a battery;
a central case for a battery housing;
a plurality of attachment arms having an inner end coupled to central case and an outer end; and
an attachment mechanism coupled to outer end of the attachment arms.

12. The mountable laptop portable charger device according to claim 11, wherein the attachment arms comprise one or more of the following: a folding arm, a fixed length arm, and extending arm, a stretchable cable, and an attachment cable coupled to one or more retractable pulleys.

13. The mountable laptop portable charger device according to claim 11, wherein the attachment mechanism comprise one or more of the following: a corner connector, an attachment clip, and an attachment pad.

14. The mountable laptop portable charger device according to claim 1, wherein the attachment pads attached to attachment arms or attachment cables that couple a laptop screen using removable mechanisms comprising one or more of the following: Velcro™, double-sided tape, rubber cement and adhesives, hooks, and linear track locks.
